(19) United States
(12) Patent Application Publication
(10) Pub. No.: US 2024/0153163 A1
(43) Pub. Date: May 9, 2024

(54) MACHINE LEARNING IN THE FIELD OF CONTRAST-ENHANCED RADIOLOGY

(71) Applicant: Bayer Aktiengesellschaft, Leverkusen (DE)

(72) Inventors: Matthias LENGA, Leverkusen (DE); Marvin PURTORAB, Hannover (DE)

(73) Assignee: Bayer Aktiengesellschaft, Leverkusen (DE)

(21) Appl. No.: 18/281,275

(22) PCT Filed: Nov. 29, 2021
(86) PCT No.: PCT/EP2021/083325

§ 371 Date: Sep. 8, 2023

(30) Foreign Application Priority Data
Mar. 9, 2021 (EP) 21161545.5
Apr. 12, 2021 (EP) 21167803.2

(51) Int. Cl. G06T 11/00; G06T 7/00

(52) U.S. Cl. CPC G06T 11/006; G06T 7/0016; G06T 2207/10088; G06T 2207/20056; G06T 2207/20081; G06T 2207/20084; G06T 2207/30061; G06T 2207/30096; G06T 2210/41; G06T 2211/441

(57) ABSTRACT

The present invention relates to the technical field of producing artificial contrast-enhanced radiological images by way of machine learning methods.

### CROSS REFERENCE TO RELATED APPLICATIONS

This application is a national stage application under 35 U.S.C. § 371 of International Application No. PCT/EP2021/083325, filed internationally on Nov. 29, 2021, which claims priority to European Application No. 21161545.5, filed on Mar. 9, 2021, and European Application No. 21167803.2, filed on Apr. 12, 2021, the entire content of each is hereby incorporated by reference in their entirety.

### FIELD

The present disclosure relates generally to the generation of artificial contrast-enhanced radiological images by means of machine learning methods.

### BACKGROUND

Radiology is a medical field which deals with imaging for diagnostic and therapeutic purposes.

Formerly, X-rays and films sensitive to X-rays were primarily used in medical imaging. Nowadays, radiology includes various different imaging methods such as for example computed tomography (CT), magnetic resonance imaging (MRI), or sonography.

With all these methods, substances known as contrast agents can be used to facilitate the depiction or delimitation of certain structures in an examination object.

In computed tomography, iodine-containing solutions are usually used as contrast agents. In magnetic resonance imaging (MRI), superparamagnetic substances (e.g., iron oxide nanoparticles, superparamagnetic iron-platinum particles (SIPPs)) or paramagnetic substances (e.g., gadolinium chelates, manganese chelates) are usually used as contrast agents.

Contrast agents can be roughly divided into the following categories based on their patterns of spreading in tissue: extracellular, intracellular and intravascular contrast agents.

The extracellular MRI contrast agents include, for example, the gadolinium chelates gadobutrol (Gadovist®), gadoteridol (Prohance®), gadoteric acid (Dotarem®), gadopentetic acid (Magnevist®), and gadodiamide (Omnican®). The highly hydrophilic properties of said gadolinium chelates and their low molecular weight lead, after intravenous administration, to rapid diffusion into the interstitial space. After a certain, comparatively short period of circulation in the blood circulation system, they are excreted via the kidneys.

Intracellular contrast agents are taken up into the cells of tissues to a certain extent and subsequently excreted.

Intracellular MRI contrast agents based on gadoxetic acid are, for example, distinguished by the fact that they are proportionately specifically taken up by liver cells, the hepatocytes, accumulate in the functional tissue (parenchyma) and enhance the contrasts in healthy liver tissue before they are subsequently excreted via the gallbladder into the faeces. Examples of such contrast agents based on gadoxetic acid are described in U.S. Pat. No. 6,039,931A; they are commercially available for example under the trade names Primovist® or Eovist®. A further MRI contrast agent having a lower uptake into the hepatocytes is gadobenate dimeglumine (Multihance®).

The contrast-enhancing effect of Primovist®/Eovist® is mediated by the stable gadolinium complex Gd-EOB-DTPA (gadolinium ethoxybenzyl diethylenetriaminepentaacetic acid). DTPA forms with the paramagnetic gadolinium ion a complex that has extremely high thermodynamic stability. The ethoxybenzyl (EOB) radical is the mediator of the hepatobiliary uptake of the contrast agent.

Intravascular contrast agents are distinguished by a distinctly longer residence time in the blood circulation system in comparison with the extracellular contrast agents. Gadofosveset is, for example, an intravascular MRI contrast agent based on gadolinium. It has been used as the trisodium salt monohydrate form (Ablavar®). It binds to serum albumin, thereby achieving the long residence time of the contrast agent in the blood circulation system (half-life in the blood about 17 hours).

In many radiological examinations, a contrast agent is administered to a patient and the dynamic spreading of the contrast agent in the body is tracked using imaging methods. For example, focal liver lesions may be detected and differentially diagnosed using dynamic contrast-enhanced magnetic resonance imaging.

Primovist® can be used for the detection of tumours in the liver. Blood supply to the healthy liver tissue is primarily achieved via the portal vein (vena portae), whereas the liver artery (arteria hepatica) supplies most primary tumours. After intravenous injection of a bolus of contrast agent, it is accordingly possible to observe a time delay between the signal rise of the healthy liver parenchyma and of the tumour.

Other than malignant tumours, benign lesions such as cysts, haemangiomas and focal nodular hyperplasias (FNH) are frequently found in the liver. Proper therapy planning requires that these benign lesions be differentiated from the malignant tumours. Primovist® can be used for the identification of benign and malignant focal liver lesions. Using T1-weighted MRI, it provides information about the character of said lesions. Differentiation is achieved by making use of the different blood supply to liver and tumour and of the temporal profile of contrast enhancement.

The contrast enhancement achieved by means of Primovist® can be divided into at least two phases: into a dynamic phase (comprising the so-called arterial phase, portal-vein phase and late phase) and the hepatobiliary phase, in which a significant uptake of Primovist® into the hepatocytes has already taken place.

In the case of the contrast enhancement achieved by Primovist® during the distribution phase, typical perfusion patterns which provide information for the characterization of the lesions are observed. Depicting the vascularization helps to characterize the lesion types and to determine the spatial relationship between tumour and blood vessels.

In the case of T1-weighted MRI images, Primovist® leads, 10-20 minutes after the injection (in the hepatobiliary phase), to a distinct signal enhancement in the healthy liver parenchyma, whereas lesions containing no hepatocytes or only a few hepatocytes, for example metastases or moderately to poorly differentiated hepatocellular carcinomas (HCCs), appear as darker regions.

Tracking the spreading of the contrast agent over time across the dynamic phase and the hepatobiliary phase thus facilitates the detection and differential diagnosis of focal liver lesions; however, the examination extends over a comparatively long time span. Over said time span, movements by the patient should be largely avoided in order to minimize movement artefacts in the MRI image. The lengthy restriction of movement can be unpleasant for a patient.

### SUMMARY

The present invention provides means for synthetically generating one or more radiological images. The synthetically generated radiological images are predicted using a machine learning model based on a temporal sequence of measured radiological images which show contrast agent enhancement varying over time. This has the advantage that a radiological examination can be quickened since not all radiological images important for a diagnosis have to be measured. Rather, one or more radiological images can be predicted (calculated) based on measured radiological images; the examination time can thus be shortened. Moreover, the prediction of radiological images is done in frequency space (and not, as is customary, in real space). As a result, it is possible to separate contrast information from detail information in radiological representations of an examination region, to limit training and prediction to the contrast information, and to then re-introduce the detail information after prediction. This procedure reduces, for example, calculation complexity. Furthermore, working in frequency space means a higher tolerance with respect to deficient image registration.

Provided herein is a computer-implemented method comprising the steps of:
receiving a plurality of first representations of an examination region of an examination object in frequency space, wherein at least some of the first representations represent the examination region during a first time span after an administration of a contrast agent,
feeding the plurality of first representations to a prediction model, wherein the prediction model has been trained on the basis of first reference representations and of second reference representations of the examination region of a multiplicity of examination objects to generate from the first reference representations, of which at least some represent the examination region during a first time span after an administration of a contrast agent in frequency space, one or more second reference representations which represent the examination region during a second time span in frequency space,
receiving one or more predicted representations of the examination region in frequency space from the prediction model, wherein the one or more predicated representations represent the examination region during a second time span,
transforming the one or more predicted representations into one or more representations of the examination region in real space, and
outputting and/or storing the one or more representations of the examination region in real space.

Additionally, provided is a system comprising:
a receiving unit,
a control and calculation unit and
an output unit,
   wherein the control and calculation unit is configured:
to prompt the receiving unit to receive a plurality of first representations of an examination region of an examination object in frequency space, wherein at least some of the first representations represent the examination region during a first time span after an administration of a contrast agent,
to feed the plurality of first representations to a prediction model, wherein the prediction model has been trained on the basis of first reference representations and second reference representations of the examination region of a multiplicity of examination objects to generate from the first reference representations, of which at least some represent the examination region during a first time span after an administration of a contrast agent in frequency space, one or more second reference representations which represent the examination region during a second time span in frequency space,
to receive one or more predicted representations of the examination region in frequency space from the prediction model, wherein the one or more predicted representations represent the examination region during a second time span,
to transform the one or more predicted representations into one or more representations of the examination region in real space, and
to prompt the output unit to output and/or to store the one or more representations of the examination region in real space.

A non-transitory computer readable storage medium is also described. The non-transitory computer readable storage medium may store instructions that, when executed by one or more processors of a computer system, cause the computer system to execute the following steps:
receiving a plurality of first representations of an examination region of an examination object in frequency space, wherein at least some of the first representations represent the examination region during a first time span after an administration of a contrast agent,
feeding the plurality of first representations to a prediction model, wherein the prediction model has been trained on the basis of first reference representations and second reference representations of the examination region of a multiplicity of examination objects to generate from the first reference representations, of which at least some represent the examination region during a first time span after an administration of a contrast agent in frequency space, one or more second reference representations which represent the examination region during a second time span in frequency space,
receiving one or more predicted representations of the examination region in frequency space from the prediction model, wherein the one or more predicated representations represent the examination region during a second time span,
transforming the one or more predicted representations into one or more representations of the examination region in real space, and
outputting and/or storing the one or more representations of the examination region in real space.

Furthermore, described is the use of a contrast agent in a method for predicting at least one radiological image, wherein the method comprises:
generating a plurality of first representations of an examination region of an examination object in frequency space, wherein at least some of the first representations represent the examination region during a first time span after an administration of the contrast agent,
feeding the plurality of first representations to a prediction model, wherein the prediction model has been trained on the basis of first reference representations and second reference representations of the examination region of a multiplicity of examination objects to generate from the first reference representations, of which at least some represent the examination region during a first time span after an administration of a contrast agent in frequency space, one or more second reference representations which represent the examination region during a second time span in frequency space,
receiving one or more predicted representations of the examination region in frequency space from the prediction model, wherein the one or more predicated representations represent the examination region during a second time span,
transforming the one or more predicted representations into one or more representations of the examination region in real space, and
outputting and/or storing the one or more representations of the examination region in real space.

Further provided is a contrast agent for use in a method for predicting at least one radiological image, wherein the method comprises the following steps:
administering the contrast agent, wherein the contrast agent spreads in an examination region of an examination object,
generating a plurality of first representations of the examination region of the examination Fexamination region during a first time span after an administration of the contrast agent,
feeding the plurality of first representations to a prediction model, wherein the prediction model has been trained on the basis of first reference representations and second reference representations of the examination region of a multiplicity of examination objects to generate from the first reference representations, of which at least some represent the examination region during a first time span after an administration of a contrast agent in frequency space, one or more second reference representations which represent the examination region during a second time span in frequency space,
receiving one or more predicted representations of the examination region in frequency space from the prediction model, wherein the one or more predicated representations represent the examination region during a second time span,
transforming the one or more predicted representations into one or more representations of the examination region in real space, and
outputting and/or storing the one or more representations of the examination region in real space.

Further provided is a kit comprising a contrast agent and a computer program product according to the invention.

### BRIEF DESCRIPTION OF THE FIGURES

The invention will be described with reference to exemplary embodiments illustrated in the following figures.

FIG. 1(a) shows a timeline of a radiological examination, according to some embodiments.

FIG. 1(b) shows another timeline of a radiological examination, according to some embodiments.

FIG. 1(c) shows another timeline of a radiological examination, according to some embodiments.

FIG. 1(d) shows another timeline of a radiological examination, according to some embodiments.

FIG. 2 shows representations of an examination region in real space and in frequency space, according to some embodiments.

FIG. 3 shows the training of a prediction model using representations of an examination region in frequency space, according to some embodiments.

FIG. 4 shows a prediction model, according to some embodiments.

FIG. 5 shows the training of a prediction model, according to some embodiments.

FIG. 6 shows uses of a trained prediction model, according to some embodiments.

FIG. 7 shows a computer system, according to some embodiments.

FIG. 8 shows a method for training a prediction model, according to some embodiments.

FIG. 9 shows another method for training a prediction model, according to some embodiments.

FIG. 10 shows a method for predicting one or more representations of an examination region, according to some embodiments.

FIG. 11 shows another method for predicting one or more representations of an examination region, according to some embodiments.

FIG. 12 shows a temporal profile of the concentrations of contrast agent in liver arteries, liver veins, and healthy liver cells after administration of a contrast agent, according to some embodiments.

### DETAILED DESCRIPTION

The invention will be more particularly elucidated below without distinguishing between the subjects of the invention (method, system, computer program product, use, contrast agent for use, kit). On the contrary, the following elucidations are intended to apply analogously to all the subjects of the invention, irrespective of in which context (method, system, computer program product, use, contrast agent for use, kit) they occur.

Where steps are stated in an order in the present description or in the claims, this does not necessarily mean that the invention is limited to the order stated. Instead, it is conceivable that the steps are also executed in a different order or else in parallel to one another, unless one step builds on another step, which absolutely requires that the step building on the previous step be executed subsequently (which will however become clear in the individual case). The orders stated are thus preferred embodiments of the invention.

The present invention makes it possible to shorten the time span of the radiological examination of an examination object.

The “examination object” is usually a living being, preferably a mammal, very particularly preferably a human.

The “examination region” is usually part of the examination object, for example an organ or part of an organ. The “examination region”, also called image volume (field of view, FOV), is in particular a volume which is imaged in radiological images. The examination region is typically defined by a radiologist, for example on an overview image (localizer). It is of course also possible for the examination region to alternatively or additionally be defined automatically, for example on the basis of a selected protocol.

The term “radiological examination” is understood to mean all imaging methods which allow an insight into an examination object with the aid of electromagnetic rays, particle radiation or mechanical waves for diagnostic, therapeutic and/or scientific purposes. The term “radiology” in the context of the present invention encompasses in particular the following examination methods: computed tomography, magnetic resonance imaging, sonography, positron emission tomography, echocardiography, scintigraphy.

In a preferred embodiment of the present invention, the radiological examination is a magnetic resonance imaging examination.

Magnetic resonance imaging, MRI for short, is an imaging method which is used especially in medical diagnostics for depicting structure and function of the tissues and organs in the human or animal body.

In MRI, the magnetic moments of protons in an examination object are aligned in a basic magnetic field, with the result that there is a macroscopic magnetization along a longitudinal direction. This is then deflected from the resting position by irradiation with high-frequency (HF) pulses (excitation). The return of the excited states to the resting position (relaxation), or magnetization dynamics, is then detected as relaxation signals by means of one or more HF receiver coils.

For spatial encoding, rapidly switched magnetic gradient fields are superimposed on the basic magnetic field. The captured relaxation signals, or detected and spatially resolved MRI data, are initially present as raw data in a frequency space, and can for example be transformed by subsequent inverse Fourier transform into real space (image space).

In the case of native MRI, the tissue contrasts are created by the different relaxation times (T1 and T2) and the proton density. T1 relaxation describes the transition of the longitudinal magnetization to its equilibrium state, T1 being the time taken to reach 63.21% of the equilibrium magnetization prior to the resonance excitation. It is also called longitudinal relaxation time or spin-lattice relaxation time. T2 relaxation describes in an analogous manner the transition of transverse magnetization to its equilibrium state.

In radiological examinations, contrast agents are commonly used for contrast enhancement.

“Contrast agents” are substances or mixtures of substances which improve the depiction of structures and functions of the body in imaging methods such as X-ray diagnostics, magnetic resonance imaging and sonography.

Examples of contrast agents can be found in the literature (see, for example, A. S. L. Jascinth et al.: Contrast Agents in computed tomography: A Review, Journal of Applied Dental and Medical Sciences, 2016, Vol. 2, Issue 2, 143-149; H. Lusic et al.: X-ray-Computed Tomography Contrast Agents, Chem. Rev. 2013, 113, 3, 1641-1666; https://www.radiology.wisc.edu/wp-content/uploads/2017/10/contrast-agents-tutorial.pdf, M. R. Nough et al.: Radiographic and magnetic resonances contrast agents: Essentials and tips for safe practices, World J Radiol. 2017 Sep. 28; 9(9): 339-349; L. C. Abonyi et al.: Intravascular Contrast Media in Radiography: Historical Development & Review of Risk Factors for Adverse Reactions, South American Journal of Clinical Research, 2016, Vol. 3, Issue 1, 1-10; ACR Manual on Contrast Media, 2020, ISBN: 978-1-55903-012-0; A. Ignee et al.: Ultrasound contrast agents, Endosc Ultrasound. 2016 November-December; 5(6): 355-362).

MRI contrast agents exert their effect by altering the relaxation times of structures that take up contrast agents. A distinction can be made between two groups of substances: paramagnetic and superparamagnetic substances. Both groups of substances have unpaired electrons that induce a magnetic field around the individual atoms or molecules. Superparamagnetic contrast agents result in a predominant shortening of T2, whereas paramagnetic contrast agents mainly lead to a shortening of T. The effect of said contrast agents is indirect, since the contrast agent itself does not emit a signal, but instead merely influences the intensity of signals in its vicinity. An example of a superparamagnetic contrast agent is iron oxide nanoparticles (SPIO, superparamagnetic iron oxide). Examples of paramagnetic contrast agents are gadolinium chelates such as gadopentetate dimeglumine (trade name: Magnevist® and others), gadoteric acid (Dotarem®, Dotagita®, Cyclolux®), gadodiamide (Omniscan®), gadoteridol (ProHance®) and gadobutrol (Gadovist®).

With the aid of the present invention, it is possible to predict one or more synthetic radiological images of an examination region. The prediction is done with the aid of a prediction model.

The prediction model is a computer-assisted model which is configured to predict, on the basis of a plurality of first representations of an examination region of an examination object in frequency space, one or more second representations of the examination region of the examination object in frequency space. At least some of the plurality of first representations represent the examination region during a first time span after the administration of a contrast agent. The at least one second representation represents the examination region during a second time span.

The term “plurality” means a number of at least two. The plurality of first representations used for prediction is usually not greater than ten.

The second time span can come before or come after the first time span. It is also conceivable that the time spans at least partially overlap or that one time span lies within the other time span.

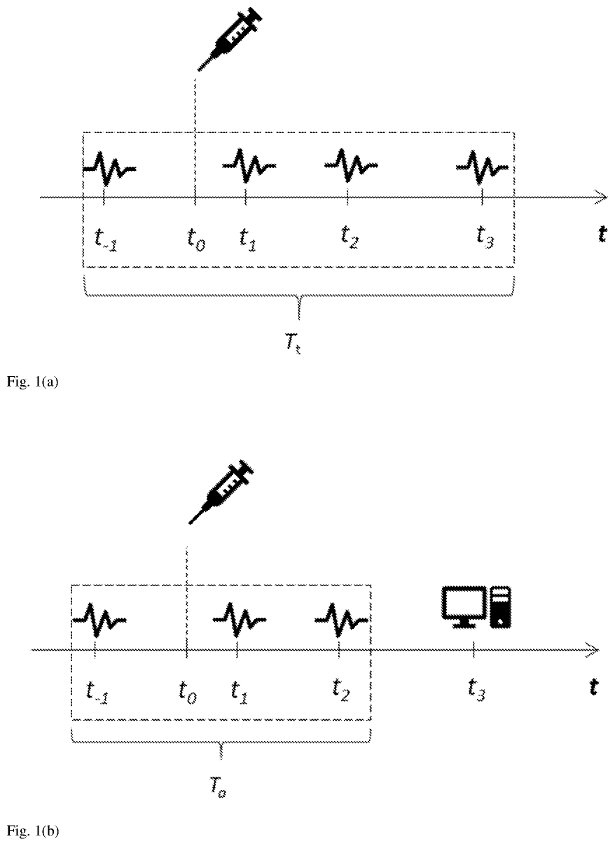

FIG. 1(a), FIG. 1(b), FIG. 1(c) and FIG. 1(d) are for the purposes of illustration. FIG. 1(a), FIG. 1(b), FIG. 1(c) and FIG. 1(d) each depict timelines. Defined time points are marked on the timelines. Time point t0 characterizes the time point at which a contrast agent is administered to an examination object. The dashed frame shows the time span in which the examination object is subjected to a radiological examination, for example the time spent by the examination object in a magnetic resonance imaging system or a computed tomography system.

FIG. 1(a) schematically illustrates a typical profile of a radiological examination. The examination object is introduced into a tomograph. At time point t−1 the examination object is situated in the tomograph. At time point t−1 a first radiological image is generated, i.e., a representation of an examination region of the examination object is generated. At said time point (t−1), contrast agent has not yet been administered to the examination object, i.e., the representation is a contrast agent-free (native) representation. At time point t0 a contrast agent is administered to the examination object situated in the tomograph. At time points t1, t2 and t3 further representations of the examination object are generated. Thereafter, the examination object leaves the tomograph. The examination object was situated in the tomograph for a comparatively long time span Tt. During this time, four representations of the examination region were generated on the basis of measurement.

FIG. 1(b) schematically illustrates a profile of a radiological examination according to the present invention. The examination object is introduced into a tomograph. At time point t−1 the examination object is situated in the tomograph. At time point t−1 a first representation of an examination region of the examination object is generated. At said time point (t−1), contrast agent has not yet been administered to the examination object, i.e., the representation is a contrast agent-free (native) representation. At time point t0 a contrast agent is administered to the examination object situated in the tomograph. At time points t1 and t2 further representations of the examination object are generated. Thereafter, the examination object leaves the tomograph. The representation generated on the basis of measurement at time point t3 in the case of FIG. 1(a) is predicted (calculated) in the case of the profile shown in FIG. 1(b). The examination object was situated in the tomograph for a time span Ta, said time span Ta being shorter than the time span Tt in FIG. 1(a). Thus, in the case of FIG. 1(b), the radiological examination does not last as long as in the case of FIG. 1(a), and it is thus more comfortable for the examination object; however, what are generated in both cases are representations of the examination region that represent the examination region at time points t−1, t1, t2 and t3. The representations which were generated on the basis of measurement at time points t−1, t1 and t2 are first representations of an examination region of an examination object in the context of the present invention, in which at least some represent an examination region during a first time span after an administration of a contrast agent, namely the representations at time points t1, t2 and t3; the representation at time point t−1 represents the examination region in a time span before the administration of the contrast agent. The representation at time point t3 is predicted by the prediction model according to the invention on the basis of the representations t−1, t1 and t2. It represents the examination region during a second time span, said second time span coming after the first time span in the case of FIG. 1(b).

FIG. 1(c) schematically illustrates a further profile of a radiological examination according to the present invention. A contrast agent is administered to the examination object at time point t0. At said time point (t0), the examination object is not yet situated in the tomograph. It is only after the contrast agent has been administered that the examination object is introduced into the tomograph. At time points t1, t2 and t3 (in a first time span after administration of the contrast agent), representations of an examination region of the examination object are generated. These represent the examination region in a first time span after administration of the contrast agent. After the generation of the representation at time point t3 the examination object can leave the tomograph; the radiological examination has ended. From the representations at time points t1, t2 and t3 it is possible to predict a representation at time point t−1. The representation at time point t−1 represents the examination region during a second time span, said second time span coming before the first time span. The examination object was situated in the tomograph for a time span Tb, said time span Tb being shorter than the time span Tt in FIG. 1(a). Thus, in the case of FIG. 1(c), the radiological examination does not last as long as in the case of FIG. 1(a), and it is thus more comfortable for the examination object; however, what are generated in both cases are representations of the examination region that represent the examination region at time points t−1, t1, t2 and t3.

FIG. 1(d) schematically illustrates a further profile of a radiological examination according to the present invention. This example is intended to make it clear that the invention is not limited to an individual administration of a contrast agent. For example, it is conceivable to perform two or more administrations. In the case of the individual administrations, it is also not necessary to administer the same contrast agent; instead, it is possible to administer different contrast agents. A (first) contrast agent is administered to the examination object at time point t0. At said time point (t0), the examination object is not yet situated in the tomograph. It is only after the contrast agent has been administered that the examination object is introduced into the tomograph. At time point t2 a first representation of an examination region of the examination object is generated. The representation at time point t2 represents the examination region in a first time span after administration of the (first) contrast agent. At time point t3 a (second) contrast agent is administered. At said time point (t3), the examination object is situated in the tomograph. After administration of the (second) contrast agent, two further representations of the examination region are generated, one at time point t4 and another at time point t5. The representations generated at time points t2, t4 and t5 are representations which represent the examination region during a first time span after an administration of a contrast agent. These representations can be used to predict a representation of the examination region at time point t−1 and/or a representation of the examination region at time point t1. The representations of the examination region at time points t−1 and t1 represent the examination region during a second time span, said second time span coming before the first time span.

Combinations of the profiles shown in FIG. 1(b), FIG. 1(c) and FIG. 1(d) and further profiles/variants are likewise possible.

In a preferred embodiment of the present invention, the first time span starts before the administration of the contrast agent or with the administration of the contrast agent. It is advantageous when one or more representations of the examination region are generated that show the examination region without contrast agent (native images), since a radiologist can already obtain important information about the health status of the examination object from such images. For example, a radiologist can identify bleedings in native MRI images.

In order for the prediction model according to the invention to be able to make the predictions described here, it must be appropriately configured beforehand.

Here, the term “prediction” means that at least one representation of an examination region that represents the examination region during a second time span in frequency space is calculated using a plurality of first representations of the examination region in frequency space, wherein at least some of the plurality of the first representations represent the examination region during a first time span after an administration of a contrast agent.

The prediction model is preferably created (configured, trained) with the aid of a self-learning algorithm in a supervised machine learning process. Training data are used for learning. Said training data comprise, for each examination object of a multiplicity of examination objects, a plurality of representations of an examination region. The examination region is usually the same for all examination objects (e.g., part of a human body or an organ or part of an organ). The representations of the training data set are also referred to as reference representations in this description. The term “multiplicity” means preferably more than 10 and even more preferably more than 100.

For each examination object, the training data comprise i) a plurality of first reference representations of the examination region in frequency space, of which at least some represent the examination region during a first time span after an administration of a contrast agent, and ii) one or more second reference representations of the examination region in frequency space that represent the examination region during a second time span.

The prediction model is trained to predict (calculate) for each examination object the one or more second reference representations from the plurality of first reference representations.

The self-learning algorithm generates, during machine learning, a statistical model which is based on the training data. This means that the examples are not simply learnt by heart, but that the algorithm “recognizes” patterns and regularities in the training data. The prediction model can thus also assess unknown data. Validation data can be used to test the quality of the assessment of unknown data.

The prediction model can be trained by means of supervised learning, i.e., pairs of data sets (first and second representations) are respectively presented in succession to the algorithm. The algorithm then learns a relationship between the first representations and the second representations.

Self-learning systems trained by means of supervised learning are widely described in the prior art (see, for example, C. Perez: Machine Learning Techniques: Supervised Learning and Classification, Amazon Digital Services LLC-Kdp Print Us, 2019, ISBN 1096996545, 9781096996545).

Preferably, the prediction model is an artificial neural network or comprises such a network.

An artificial neural network comprises at least three layers of processing elements: a first layer with input neurons (nodes), an N-th layer with at least one output neuron (nodes) and N-2 inner layers, where N is a natural number and greater than 2.

The input neurons serve to receive first representations. The output neurons serve to output one or more second representations for a plurality of first representations.

The processing elements of the layers between the input neurons and the output neurons are connected to one another in a predetermined pattern with predetermined connection weights.

Preferably, the artificial neural network is a so-called convolutional neural network (CNN for short).

A convolutional neural network is capable of processing input data in the form of a matrix. A CNN consists essentially of filters (convolutional layer) and aggregation layers (pooling layer) which are repeated alternately and, at the end, of one layer or multiple layers of “normal” completely connected neurons (dense/fully connected layer).

The training of the neural network can, for example, be carried out by means of a backpropagation method. The aim here in respect of the network is maximum reliability of mapping of given input data onto given output data. The mapping quality is described by a loss function. The goal is to minimize the loss function. In the case of the backpropagation method, an artificial neural network is taught by the alteration of the connection weights.

In the trained state, the connection weights between the processing elements contain information regarding the relationship between first representations and one or more second representations that can be used in order to predict one or more second representations showing an examination region during a second time span for a new plurality of first representations (e.g., of a new examination object), of which at least some show the examination region during a first time span after administration of a contrast agent.

A cross-validation method can be used in order to divide the data into training and validation data sets. The training data set is used in the backpropagation training of network weights. The validation data set is used in order to check the accuracy of prediction with which the trained network can be applied to unknown data.

Further details on the construction and training of artificial neural networks can be gathered from the prior art (see for example: S. Khan et al.: A Guide to Convolutional Neural Networks for Computer Vision, Morgan & Claypool Publishers 2018, ISBN 1681730227, 9781681730226, WO2018/183044A1, WO2018/200493, WO2019/074938A1, WO2019/204406A1, WO2019/241659A1).

Preferably, the prediction model is a generative adversarial network (GAN) (see for example: http://3dgan.csail.mit.edu/).

In addition to the representations, further information about the examination object, about the examination region, about examination conditions and/or about the radiological examinations can also be used for training, validation and prediction.

Examples of information about the examination object are: sex, age, weight, height, anamnesis, nature and duration and amount of medicaments already ingested, blood pressure, central venous pressure, breathing rate, serum albumin, total bilirubin, blood sugar, iron content, breathing capacity and the like. These can, for example, be read from a database or an electronic patient file.

Examples of information about the examination region are: pre-existing conditions, operations, partial resection, liver transplantation, iron liver, fatty liver and the like.

As already described, the representations of the examination region that are used for training, validation and prediction are representations of the examination region in frequency space (also referred to as spatial frequency space or Fourier space or frequency domain or Fourier representation).

In magnetic resonance imaging, the raw data usually arise as so-called k-space data owing to the above-described measurement method. Said k-space data are a depiction of an examination region in a frequency space, i.e., such k-space data can be used for training, validation and prediction. If representations in real space are present, such representations in real space can be converted (transformed) by Fourier transform into a representation in frequency space; conversely: representations in frequency space can, for example, be converted (transformed) by inverse Fourier transform into a representation in real space.

Thus, if a radiological image of an examination region is present in the form of a two-dimensional image in real space, this representation of the examination region can be converted by a 2D Fourier transform into a two-dimensional representation of the examination region in frequency space.

A three-dimensional image (volume depiction) of an examination region can be treated as a stack of two-dimensional images. Furthermore, it is conceivable that the three-dimensional image is converted by means of 3D Fourier transform into a three-dimensional representation of the examination region in frequency space.

It is also conceivable to use a transform other than the Fourier transform in order to convert real-space representations into frequency-space representations. The three main properties which must be satisfied by such a transform are:
a) existence of a clear inverse transform (clear connection between real-space depiction and frequency-space depiction),
b) locality of the contrast information, and
c) robustness with respect to deficient image registration.

Details on transformation from one depiction into another are described in a multitude of textbooks and publications (see for example: W. Burger, M. J. Burge: Digital Image Processing: An Algorithmic Introduction Using Java, Texts in Computer Science, 2nd edition, Springer-Verlag, 2016, ISBN: 9781447166849; W. Birkfellner: Applied Medical Image Processing, Second Edition: A Basic Course, Verlag Taylor & Francis, 2014, ISBN: 9781466555570; R. Bracewell: Fourier Analysis and Imaging, Verlag Springer Science & Business Media, 2004, ISBN: 9780306481871).

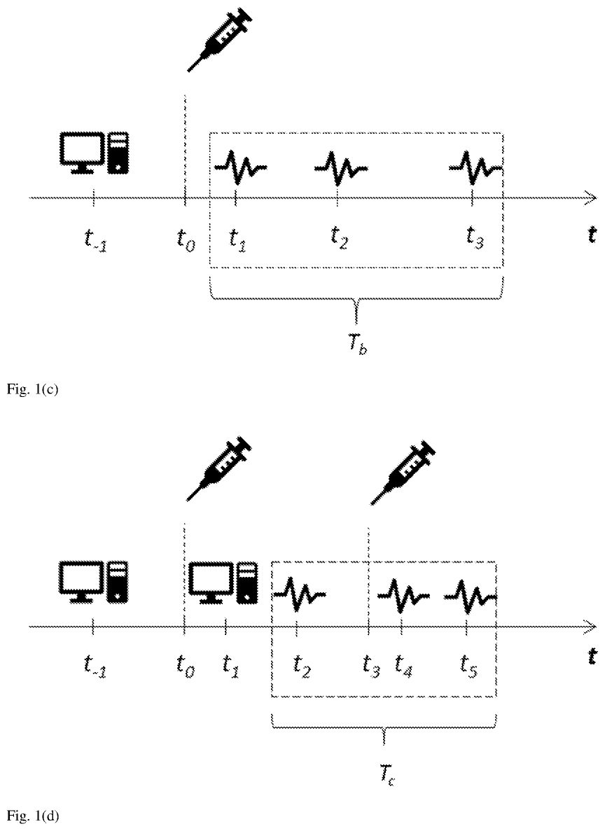

FIG. 2 shows exemplarily and schematically the generation of representations of an examination region in real space and in frequency space.

FIG. 2 depicts a timeline. At three different time points t1, t2 and t3 representations of an examination region are generated on the basis of measurement. The examination region is the lung of a human. At time point t1 a first representation is generated. This can be a representation (O1) of the examination region (lung) in real space or a representation (F1) of the examination region (lung) in frequency space. The representation (O1) of the examination region in real space can be converted by means of Fourier transform FT into a representation (F1) of the examination region in frequency space. The representation (F1) of the examination region in frequency space can be converted by means of inverse Fourier transform iFT into a representation (O1) of the examination region in real space. The two representations (O1) and (F1) comprise the same information about the examination region, just in a different depiction. At time point t2 a further representation is generated. This can be a representation (O2) of the examination region (lung) in real space or a representation (F2) of the examination region (lung) in frequency space. The representation (O2) of the examination region in real space can be converted by means of Fourier transform FT into a representation (F2) of the examination region in frequency space. The representation (F2) of the examination region in frequency space can be converted by means of inverse Fourier transform iFT into a representation (O2) of the examination region in real space. The two representations (O2) and (F2) comprise the same information about the examination region, just in a different depiction. At time point t3 a further representation is generated. This can be a representation (O3) of the examination region (lung) in real space or a representation (F3) of the examination region (lung) in frequency space. The representation (O3) of the examination region in real space can be converted by means of Fourier transform FT into a representation (F3) of the examination region in frequency space. The representation (F3) of the examination region in frequency space can be converted by means of inverse Fourier transform iFT into a representation (O3) of the examination region in real space. The two representations (O3) and (F3) comprise the same information about the examination region, just in a different depiction.

The representations (O1), (O2) and (O3) of the examination region in real space are the familiar representations for humans; they can be immediately grasped by humans. The representations (O1), (O2) and (O3) show how contrast agent dynamically spreads in the veins. The same information is contained in the representations (F1), (F2) and (F3), just more difficult to grasp for humans.

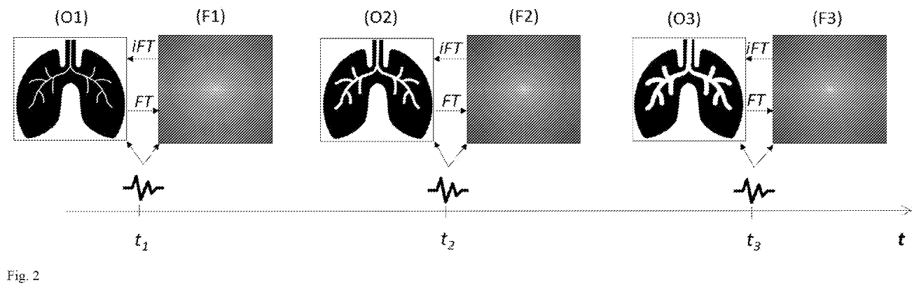

FIG. 3 shows schematically and exemplarily how the representations of the examination region (F1), (F2) and (F3) in frequency space as generated in FIG. 2 can be used for training a prediction model (PM). The representations (F1), (F2) and (F3) form a set of training data of an examination object. The training is done using a multiplicity of training data sets of a multiplicity of examination objects.

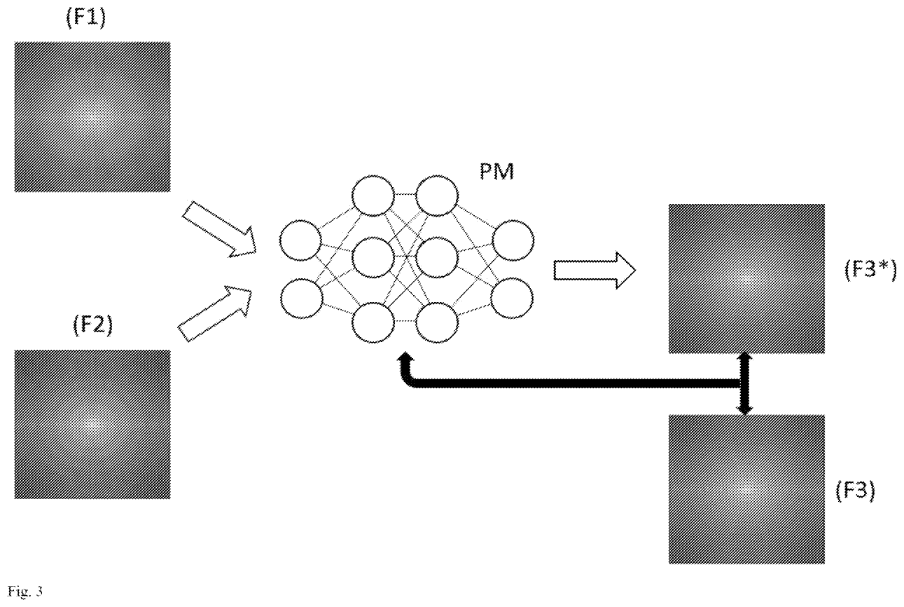

The representations (F1) and (F2) are a plurality (two in the present case) of first reference representations of the examination region in frequency space, of which at least some represent the examination region during a first time span after an administration of a contrast agent. The representation (F3) is a second reference representation of the examination region in frequency space that represents the examination region during a second time span. In FIG. 3, the prediction model is trained to predict the representation (F3) of the examination region in frequency space from the representations (F1) and (F2) of the examination region in frequency space. The representations (F1) and (F2) are input into the prediction model (PM) and the prediction model calculates a representation (F3*) from the representations (F1) and (F2). The asterisk (*) signals that the representation (F3*) is a predicted representation. The calculated representation (F3*) is compared with the representation (F3). The deviations can be used in a backpropagation method to train the prediction model to reduce the deviations to a defined minimum. If the prediction model has been trained on the basis of a multiplicity of training data sets of a multiplicity of examination objects and if the prediction has reached a defined accuracy, the trained prediction model can be used for prediction. This is depicted exemplarily and schematically in FIG. 4.

FIG. 4 shows the prediction model (PM) trained in FIG. 3. The prediction model is used to generate, on the basis of a plurality of first representations of the examination region in frequency space, of which at least some represent the examination region in a first time span after administration of a contrast agent, one or more second representations of the examination region in frequency space, said one or more second representations representing the examination region in a second time span.

In the present example, two first representations (\tilde{F}1) and (\tilde{F}2) of the examination region in frequency space are input into the prediction model (PM) and the prediction model (PM) generates (calculates) a second representation (\tilde{F}3*). The tilde (˜) signals that the representations are representations of a new examination object, of which usually no representations are present that have been used in the training method for the training of the prediction model. The asterisk (*) signals that the representation (\tilde{F}3*) is a predicted representation. The representation (\tilde{F}3*) of the examination region in frequency space can, for example, be transformed by means of inverse Fourier transform iFT into a representation (Õ3*) of the examination region in real space.

The use of representations of the examination region in frequency space has advantages over the use of representations of the examination region in real space (also called image space). When representations of the examination region in frequency space are used, contrast information, which is important for training and for prediction, can be separated from detail information (fine structures). It is thus possible to concentrate, in the case of training, on the information to be learnt by the prediction model and to also concentrate, in the case of prediction, on the information to be predicted by the prediction model: contrast information.

Whereas contrast information in a representation of an examination region in real space is usually distributed over the entire representation (each pixel/voxel intrinsically bears information about contrast), the contrast information in a representation of an examination region in frequency space is encoded in and around the center of the frequency space. In other words: the low frequencies in a representation in frequency space are responsible for the contrast, whereas the high frequencies contain information about fine structures.

It is thus possible to separate the contrast information, to limit training and prediction to the contrast information and to re-introduce information about the fine structures after training/after prediction.

In a preferred embodiment, the method according to invention comprises the following steps:
receiving a plurality of first representations of an examination region of an examination object in frequency space, wherein at least some of the first representations represent the examination region during a first time span after an administration of a contrast agent,
specifying a region in the first representations, wherein the specified region comprises the center of the frequency space,
reducing the first representations to the specified region, wherein a plurality of reduced first representations is obtained,
feeding the plurality of reduced first representations to a prediction model,
receiving one or more second representations of the examination region in frequency space from the prediction model, wherein the one or more second representations represent the examination region during a second time span,
supplementing the one or more second representations by one or more regions of the received first representations that lie outside the specified region, wherein one or more supplemented second representations are obtained,
transforming the one or more supplemented second representations into one or more representations of the examination region in real space, and
outputting and/or storing the one or more representations of the examination region in real space.

Specification of the region in the first representations can, for example, be achieved by a user of the computer system according to the invention inputting one or more parameters into the computer system according to the invention and/or making a selection from a list which defines the shape and/or size of the region. However, it is also conceivable that specification is carried out automatically, for example by the computer system according to the invention, which has been appropriately configured to select a predefined region in the representations of the examination region.

The specified region is usually smaller than the frequency space filled by the first representations, but comprises in any case the center of the frequency space.

A region of the frequency space that comprises the center of the frequency space (also called origin or zero point) contains the contrast information relevant to the method according to the invention. If the specified region is smaller than the frequency space filled by the first representations, the result is a lower calculation complexity for the subsequent prediction (this especially also applies to the training of the prediction model). Selection of the size of the region can thus have a direct influence on calculation complexity.

It is in principle also possible to specify a region which corresponds to the entire frequency space which is filled by the first representations; in such a case, there is no reduction to a subregion of the frequency space and the calculation complexity is maximal.

Thus, by specification of a region around the center of the frequency space, the user of the computer system according to the invention can himself decide whether he wants the complete representations of the examination region in frequency space to form the basis of training and prediction or whether he would like to reduce calculation complexity. Here, he can directly influence the required calculation complexity through the size of the specified region.

The specified region usually has the same dimension as the frequency space: in the case of a 2D representation in a 2D frequency space, the specified region is usually an area; in the case of a 3D representation in a 3D frequency space, the specified region is usually a volume.

The specified region can in principle have any shape; it can thus, for example, be round and/or angular, concave and/or convex. Preferably, the region is cuboid or cube-shaped in the case of a 3D frequency space in a Cartesian coordinate system and rectangular or square in the case of a 2D frequency space in a Cartesian coordinate system. However, it can also be spherical or circular or have another shape.

Preferably, the geometric center of gravity of the specified region coincides with the center of the frequency space.

The representations used for training, validation and prediction are reduced to the specified region. The term “reduce” means here that all the parts of a representation that do not lie in the specified region are cut away (discarded) or are covered by a mask. In the case of masking, those regions which lie outside the specified region are covered with a mask, with the result that only the specified region remains uncovered; when covering with a mask, for example the colour values of the corresponding pixels/voxels can for example be set to zero (black).

The representations thus obtained are also referred to as reduced representations in this description.

The first representations obtained after reduction (reduced first representations) are fed to the prediction model: The prediction model has been trained beforehand in a training method to learn the dynamic influence of the amount of contrast agent on representations of the examination region in frequency space. Training preferably likewise makes use of reduced representations (reduced first representations and reduced second representations).

The prediction model has thus learnt what dynamic influence is had by contrast agent on a representation of the examination region and can apply this learnt “knowledge” in order to predict one or more (reduced) second representations on the basis of the (reduced) first representations.

The one or more predicted second representations represent the examination region in frequency space during a second time span.

The one or more predicted second representations are calculated and output by the prediction model on the basis of the (reduced) first representations.

If the at least one predicted second representation has been generated on the basis of reduced first representations, it is then appropriate to re-add the previously discarded parts (cut away or covered with a mask) in order not to lose information about fine structures in the final artificially generated image as far as possible.

In order to re-use the previously discarded parts (cut away or covered with a mask), the at least one predicted second representation can be superimposed with at least one received first representation such that the at least one predicted second representation replaces the corresponding superimposed frequency regions of the at least one originally received first representation. Preferably, the predicted second representation replaces the corresponding frequency regions of that originally received first representation which represents the examination region without contrast agent.

Replacement of the superimposed frequency region corresponds to supplementation by one or more regions of the frequency space of the received first representations that were omitted when reducing the first representations to the specified region.

In other words: the frequency space of the at least one predicted second representation of the examination region is filled up by those regions of at least one originally received first representation, by which the at least one originally received first representation is greater than the predicted second representation.

By using representations of the examination region in frequency space, it is thus possible to separate contrast information from detail information, to limit training and prediction to the contrast information and to then re-introduce the detail information after training and/or prediction. As already described, this procedure reduces calculation complexity during training, validation and prediction.

Working in frequency space has, however, yet another advantage over working in real space: co-registration of the individual representations is less critical in frequency space than in real space. “Co-registration” (also called “image registration” in the prior art) is an important process in digital image processing and serves to bring two or more images of the same scene, or at least similar scenes, in harmony with one another in the best possible way. One of the images is defined as the reference image and the others are called object images. In order to optimally match said object images with the reference image, a compensating transformation is calculated. The images to be registered differ from one another because they were acquired from different positions, at different time points and/or with different sensors.

In the case of the present invention, the individual representations of the plurality of first representations of the examination region were, firstly, generated at different time points; secondly, they differ with respect to the content and the spreading of contrast agent in the examination region.

The use of representations of the examination region in frequency space has, then, the advantage over the use of representations of the examination region in real space that the training, validation and prediction methods are more tolerant with respect to errors in image registration. In other words: if representations in frequency space are not superimposed with accuracy, this has less influence than if representations in real space are not superimposed with pixel/voxel-accuracy. This is due to the properties of the Fourier transform: as already described, the contrast information of Fourier-transformed images is always mapped in the vicinity of the origin (center) of the Fourier space. Turns or rotations in image space (real space) lead to image information (e.g., a visible structure) being localized in a different region of the image after the transformation. However, in Fourier space, these transformations do not change the region in which the contrast information relevant to the present invention is encoded.

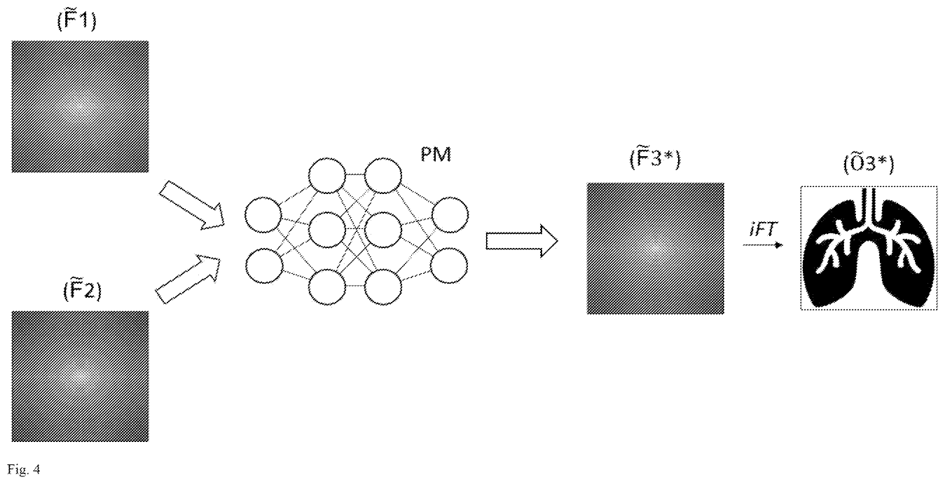

FIG. 5 shows exemplarily and schematically a step in the training of a prediction model according to a preferred embodiment of the present invention.

What are received are two first representations (F1) and (F2) of an examination object in frequency space and a second representation (F3) of the examination object in frequency space. In the representations (F1), (F2) and (F3), the same region A is specified in each case. The region A comprises the center of the frequency space and has, in the present case, a square shape, with the geometric eee center of gravity of the square coinciding with the center of the frequency space. The representations (F1), (F2) and (F3) are reduced to the respectively specified region A: the result is three reduced representations (F1red), (F2red) and (F3red). The reduced representations are used for the training. The prediction model is trained to predict the reduced representation (F3red) from the reduced representations (F1red) and (F2red). The reduced representations (F1red) and (F2red) are fed to the prediction model (PM) and the prediction model calculates a reduced representation (F3*red) which is to come as close as possible to the reduced representation (F3red).

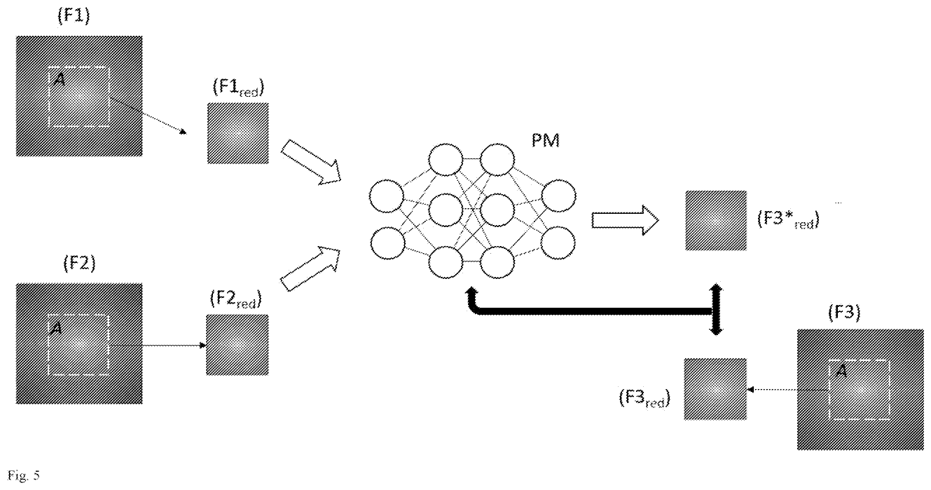

FIG. 6 shows exemplarily and schematically how the prediction model trained in FIG. 5 can be used for prediction.

In the present example, two first representations (\tilde{F}1) and (\tilde{F}2) of the examination region in frequency space are received and respectively reduced to a specified region A. The result is two reduced first representations (\tilde{F}1red) and (\tilde{F}2red). The reduced first representations (\tilde{F}1red) and (\tilde{F}2red) are fed to the trained prediction model (PM). The trained prediction model (PM) calculates a reduced second representation (\tilde{F}3red*) from the reduced first representations (\tilde{F}1red) and (\tilde{F}2red). The reduced second representation (\tilde{F}3red*) is supplemented in a further step by that region (\tilde{F}1DI) of the received first representation (\tilde{F}1) that was discarded when reducing the received first representation (\tilde{F}1) (by the region which lies outside the specified region A). As described, instead of or in addition to parts of the received first representation (\tilde{F}1), it is also possible to add parts of the received second representation (\tilde{F}2) to the reduced third representation (\tilde{F}3red*).

From the supplemented representation (\tilde{F}3red*)+(\tilde{F}1DI), it is possible to generate by inverse Fourier transform a representation of the examination region in real space (Õ3*).

It should be noted that other methods can also be used for transformation of a frequency-space depiction into a real-space depiction, such as, for example, iterative reconstruction methods.

The method according to the invention can be executed with the aid of a computer system. The present invention further provides a computer system which has been configured (e.g., with the aid of the computer program according to the invention) to execute the method according to the invention.

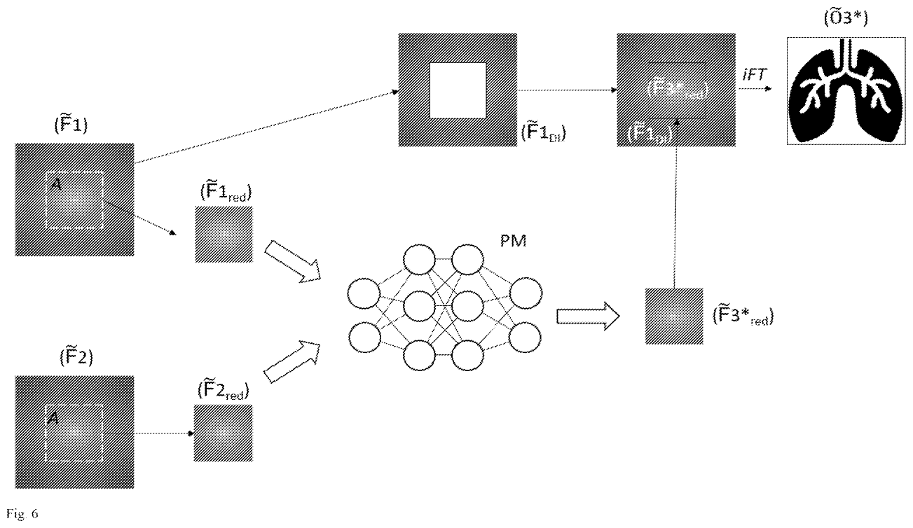

FIG. 7 shows schematically and exemplarily one embodiment of the computer system according to the invention. The computer system (10) comprises a receiving unit (11), a control and calculation unit (12) and an output unit (13).

A “computer system” is a system for electronic data processing that processes data by means of programmable computation rules. Such a system usually comprises a control and calculation unit, often also referred to as “computer”, said unit comprising a processor for carrying out logical operations and a memory for loading a computer program, and also a peripheral.

In computer technology, “peripherals” refers to all devices that are connected to the computer and are used for control of the computer and/or as input and output devices. Examples thereof are monitor (screen), printer, scanner, mouse, keyboard, joystick, drives, camera, microphone, speakers, etc. Internal ports and expansion cards are also regarded as peripherals in computer technology.

Today's computer systems are commonly subdivided into desktop PCs, portable PCs, laptops, notebooks, netbooks and tablet PCs, and so-called handhelds (e.g., smartphones); all such systems can be used for execution of the invention.

Inputs into the computer system (e.g., for control by a user) are achieved via input means such as, for example, a keyboard, a mouse, a microphone, a touch-sensitive display and/or the like. Outputs are achieved via the output unit (13), which can be especially a monitor (screen), a printer and/or a data storage medium.

The computer system (10) according to the invention is configured to predict, from a plurality of first representations of an examination region of an examination object in frequency space that represent the examination region during a first time span after an administration of a contrast agent, one or more second representations of the examination region of the examination object in frequency space, wherein the one or more second representations represent(s) the examination region during a second time span.

The control and calculation unit (12) serves for control of the receiving unit (11) and the output unit (13), coordination of the data and signal flows between the various units, processing of representations of the examination region and generation of artificial radiological images. It is conceivable that multiple control and calculation units are present.

The receiving unit (11) serves for receiving representations of an examination region. The representations can, for example, be transmitted from a magnetic resonance imaging system or be transmitted from a computed tomography system or be read from a data storage medium. The magnetic resonance imaging system or the computed tomography system can be a component of the computer system according to the invention. However, it is also conceivable that the computer system according to the invention is a component of a magnetic resonance imaging system or a computed tomography system. Representations can be transmitted via a network connection or a direct connection. Representations can be transmitted via radio communication (WLAN, Bluetooth, mobile communications and/or the like) and/or via a cable. It is conceivable that multiple receiving units are present. The data storage medium, too, can be a component of the computer system according to the invention or be connected thereto, for example via a network. It is conceivable that multiple data storage media are present.

The representations and possibly further data (such as, for example, information about the examination object, image-acquisition parameters and/or the like) are received by the receiving unit and transmitted to the control and calculation unit.

The control and calculation unit is configured to generate artificial radiological images on the basis of the received data.

Via the output unit (13), the artificial radiological images can be displayed (e.g., on a monitor), be output (e.g., via a printer) or be stored in a data storage medium. It is conceivable that multiple output units are present.

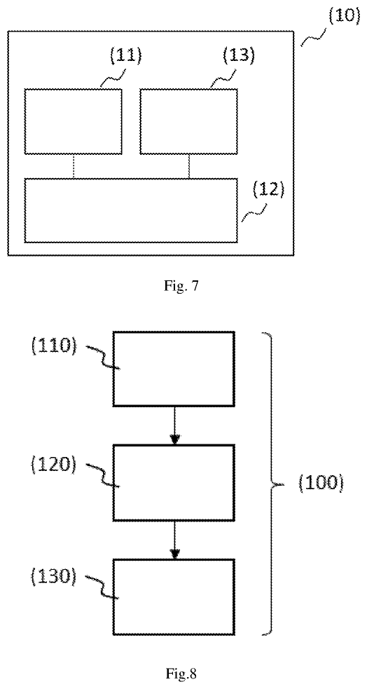

FIG. 8 shows exemplarily in the form of a flow chart a preferred embodiment of the method according to the invention for training a prediction model.

The method (100) comprises the following steps:
(110) receiving training data, wherein the training data comprise, for each examination object of a multiplicity of examination objects, i) a plurality of first reference representations of an examination region in frequency space, of which at least a portion represents the examination region during a first time span after an administration of a contrast agent, and ii) one or more second reference representations of the examination region in frequency space that represent the examination region during a second time span,
(120) for each examination object: feeding the plurality of first reference representations to a prediction model, wherein the prediction model is trained to generate one or more second reference representations on the basis of the plurality of first reference representations, wherein the training comprises the minimization of a loss function, wherein the loss function quantifies deviations of the generated second reference representation(s) from the one or more received second reference representation(s), and
(130) outputting and/or storing the trained prediction model and/or supplying the trained prediction model to a method for predicting one or more representations of the examination region of a new examination object.

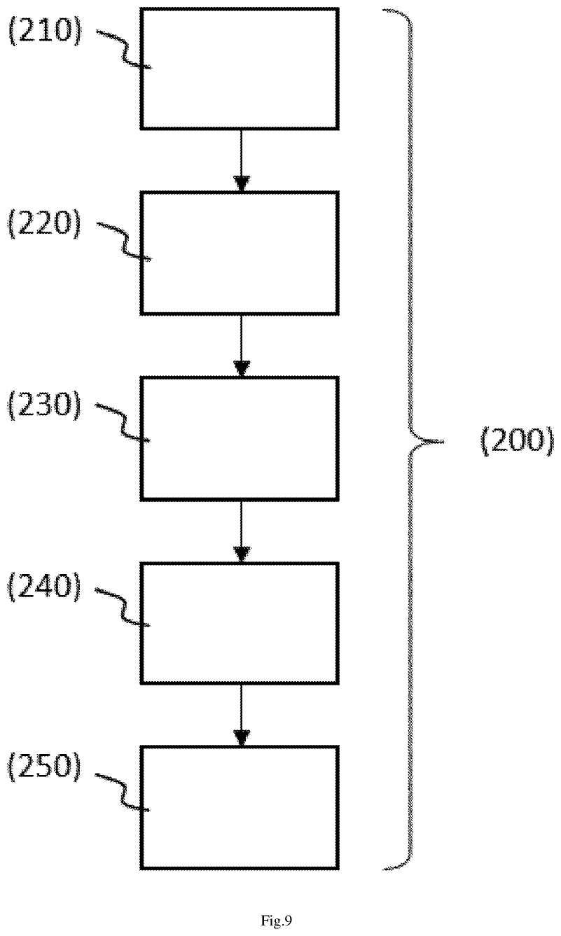

FIG. 9 shows exemplarily in the form of a flow chart a further preferred embodiment of the method according to the invention for training a prediction model.

The method (200) comprises the following steps:
(210) receiving training data, wherein the training data comprise, for each examination object of a multiplicity of examination objects, i) a plurality of first reference representations of an examination region in frequency space, of which at least a portion represents the examination region during a first time span after an administration of a contrast agent, and ii) one or more second reference representations of the examination region in frequency space that represent the examination region during a second time span,
(220) specifying a region in the first reference representations, wherein the specified region comprises the center of the frequency space,
(230) reducing the reference representations to the specified region, wherein a plurality of reduced first reference representations and one or more reduced second reference representation(s) are obtained for each examination object,
(240) for each examination object: feeding the plurality of reduced first reference representations to a prediction model, wherein the prediction model is trained to generate one or more reduced second reference representations on the basis of the plurality of reduced first reference representations, wherein the training comprises the minimization of a loss function, wherein the loss function quantifies deviations of the generated reduced second reference representation(s) from the one or more reduced second reference representation(s) of the training data, and
(250) outputting and/or storing the trained prediction model and/or supplying the trained prediction model to a method for predicting one or more representations of the examination region of a new examination object.

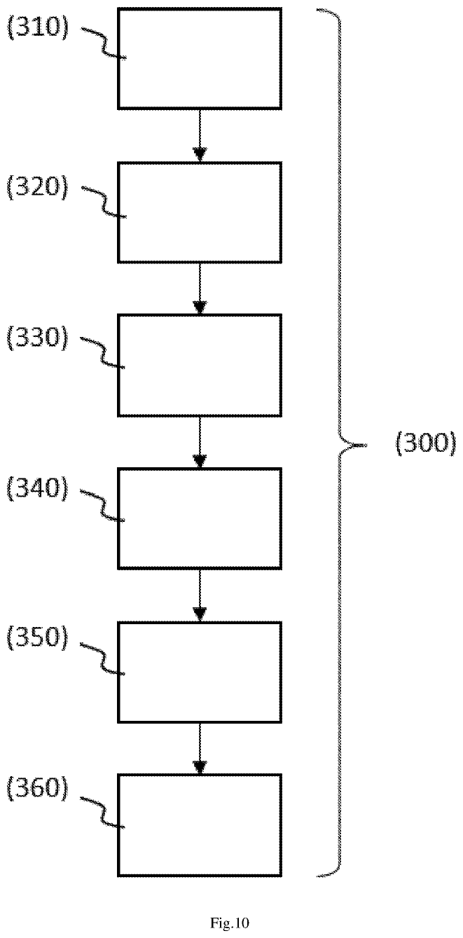

FIG. 10 shows exemplarily in the form of a flow chart a preferred embodiment of the method according to the invention for predicting one or more representations.

The method (300) comprises the following steps:
(310) providing a prediction model, wherein the prediction model has been trained according to the above-described method (100),
(320) receiving a plurality of first representations of an examination region of an examination object in frequency space, wherein at least a portion of the first representations represent the examination region during a first time span after an administration of a contrast agent,
(330) feeding the plurality of first representations to the prediction model,
(340) receiving from the prediction model one or more predicted representations of the examination region in frequency space, wherein the one or more predicted representations represent the examination region during a second time span,
(350) transforming the one or more predicted representations into one or more representations of the examination region in real space, and
(360) outputting and/or storing the one or more representations of the examination region in real space.

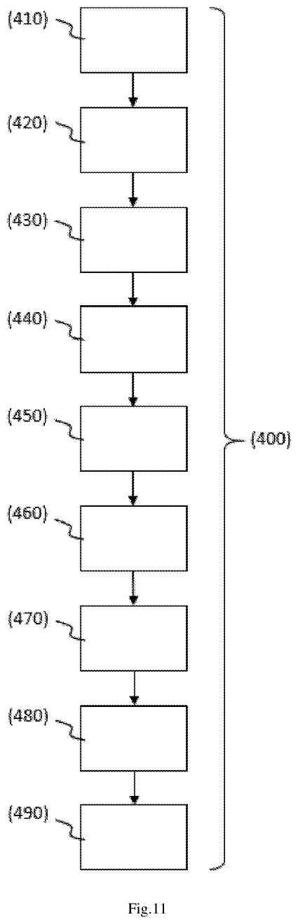

FIG. 11 shows exemplarily in the form of a flow chart a further preferred embodiment of the method according to the invention for predicting one or more representations.

The method (400) comprises the following steps:
(410) providing a prediction model, wherein the prediction model has been trained according to the above-described method (200),
(420) receiving a plurality of first representations of an examination region of an examination object in frequency space, wherein at least a portion of the first representations represent the examination region during a first time span after an administration of a contrast agent,
(430) specifying a region in the first representations, wherein the specified region comprises the center of the frequency space,
(440) reducing the first representations to the specified region, wherein a plurality of reduced first representations are obtained,
(450) feeding the plurality of reduced first representations to the prediction model,
(460) receiving from the prediction model one or more second representations of the examination region in frequency space, wherein the one or more second representations represent the examination region during a second time span,
(470) supplementing the one or more second representations by one or more regions of the received first representations that lie outside the specified region, wherein one or more supplemented second representations are obtained, and
(480) transforming the one or more supplemented second representations into one or more representations of the examination region in real space,
(490) outputting and/or storing the one or more representations of the examination region in real space.

Listed below are a few examples of how the present invention can be used to generate artificial radiological images.

### Example 1

In one embodiment, the present invention is used to simulate an intravascular contrast agent (also referred to as blood pool (contrast) agent).

When generating radiological images with a comparatively long acquisition time/scanning time, for example image acquisition under free breathing of thorax and abdomen to depict the vascular system (e.g., diagnostics for pulmonary embolism under free breathing in MRI), an extracellular contrast agent is eliminated comparatively rapidly from the blood vessel system, meaning that the contrast drops rapidly. It would be advantageous, however, to be able to maintain the contrast for a longer period of time.

In order to solve this problem, a plurality of first representations of an examination region in frequency space are generated/received in a first step, wherein at least some of the first representations represent the examination region after administration of a contrast agent.

The administered contrast agent can be an extracellular and/or an intracellular contrast agent.

The contrast agent is preferably introduced into a blood vessel of the examination object, for example into an arm vein, using dosing based on body weight. From there, it moves with the blood along the blood circulation system.

The “blood circulation system” is the path covered by the blood in the body of humans and most animals. It is the flow system of the blood that is formed by the heart and by a network of blood vessels (cardiovascular system, blood vessel system).

An extracellular contrast agent circulates in the blood circulation system for a period of time that is dependent on the examination object, the contrast agent and the administered amount, while it is continuously eliminated from the blood circulation system via the kidneys.

While the contrast agent spreads and/or circulates in the blood vessel system of the examination object, at least one first representation of the blood vessel system or of a portion thereof is captured. Multiple first representations can be captured that represent the different phases of the spreading of the contrast agent in the blood vessel system or in a portion thereof (e.g., distribution phase, arterial phase, venous phase and/or the like). The capture of multiple images allows later differentiation of blood vessel types.

The measured representations represent the blood vessel system or a portion thereof with contrast enhancement with respect to the surrounding tissue. Preferably, at least one representation shows arteries with contrast enhancement (arterial phase), whereas at least one further representation shows veins with contrast enhancement (venous phase).

Artificial representations are generated on the basis of the measured representations. The artificial representations preferably show the same examination region as the measured representations. If a plurality of measured representations of the examination region was captured at different time points after the administration of the contrast agent, the later representations in particular show blood vessels with an increasingly falling contrast with respect to the surrounding tissue, since the contrast agent is gradually being eliminated from the blood vessels. By contrast, the artificial representations show the blood vessels with a consistently high contrast with respect to the surrounding tissue.

This is achieved by the measured representations being fed to the prediction model according to the invention, which has been trained beforehand to predict, on the basis of measured representations showing a contrast enhancement of blood vessels that varies over time, multiple representations showing a contrast enhancement of blood vessels that is constant over time.

The reference data which are used for training and validation of such a prediction model usually comprise measured representations of the examination region after the administration of an extracellular or intracellular contrast agent. The reference data can further comprise representations of the examination region after the administration of a blood pool contrast agent. Such reference data can, for example, be ascertained in a clinical study. An intravascular contrast agent which can be used in such a clinical study is, for example, ferumoxytol. Ferumoxytol is a colloidal iron-carbohydrate complex which has been authorized for parenteral treatment of an iron deficiency in a chronic kidney disease when it is not possible to carry out an oral therapy. Ferumoxytol is administered as an intravenous injection. Ferumoxytol is commercially available as a solution for intravenous injection under the trade names Rienso® or Ferahme®. The iron-carbohydrate complex shows superparamagnetic properties and can therefore be used (off-label) for contrast enhancement in MRI examinations (see for example: L.P. Smits et al.: Evaluation of ultrasmall superparamagnetic iron-oxide (USPIO) enhanced MRI with ferumoxytol to quantify arterial wall inflammation, Atherosclerosis 2017, 263: 211-218).

It is similarly conceivable to use representations after administration of the intravascular contrast agent Ablavar® as training data.

It is similarly conceivable to synthetically generate the reference representations showing blood vessels in the examination region with a contrast enhancement that is constant over time, for example by means of segmentation methods on the basis of the first representations. Segmentation methods are widely described in the literature. The following publications may be given as examples: F. Conversano et al.: Hepatic Vessel Segmentation for 3D Planning of Liver Surgery, Acad Radiol 2011, 18: 461-470; S. Moccia et al.: Blood vessel segmentation algorithms—Review of methods, datasets and evaluation metrics, Computer Methods and Programs in Biomedicine 158 (2018) 71-91; M. Marcan et al.: Segmentation of hepatic vessels from MRI images for planning of electroporation-based treatments in the liver, Radiol Oncol 2014; 48(3): 267-281; T. A. Hope et al.: Improvement of Gadoxetate Arterial Phase Capture With a High Spatio-Temporal Resolution Multiphase Three-Dimensional SPGR-Dixon Sequence, Journal of Magnetic Resonance Imaging 38: 938-945 (2013); WO2009/135923A1, U.S. Pat. No. 6,754,376B1, WO2014/162273A1, WO2017/139110A1, WO2007/053676A2, EP2750102A1).

On the basis of the first representations that have been fed, the trained prediction model then generates second representations showing a contrast enhancement of the blood vessels that is constant over time.

### Example 2

In a preferred embodiment, the present invention is used to generate (predict) one or more artificial MRI images in dynamic contrast-enhanced magnetic resonance imaging.

In the text which follows, the term “image” is used. An “image” is a representation in the context of the present invention. An image can be a representation in real space or a representation in frequency space. For training of the prediction model and for prediction, use is always made of representations in frequency space; i.e., k-space data for example. However, if representations in real space are generated on the basis of measurement, they can, for example, be converted by means of Fourier transform into representations in frequency space before they are introduced to training and/or prediction.

The examination region is introduced into a basic magnetic field. The examination region is subjected to an MRI method and, in the course of this, a plurality of MRI images showing the examination region during a first time span is generated. These MRI images generated on the basis of measurement during the first time span are also referred to as first MRI images in this description.

The term “plurality” means that at least two (first) MRI images, preferably at least three (first) and very particularly preferably at least four (first) MRI images, are generated.

A contrast agent which spreads in the examination region is administered to the examination object. The contrast agent is preferably administered intravenously as a bolus using dosing based on body weight (e.g., into an arm vein).

Preferably, the contrast agent is a hepatobiliary contrast agent such as, for example, Gd-EOB-DTPA or Gd-BOPTA. In a particularly preferred embodiment, the contrast agent is a substance or a substance mixture having gadoxetic acid or a salt of gadoxetic acid as contrast-enhancing active substance. Very particular preference is given to the disodium salt of gadoxetic acid (Gd-EOB-DTPA disodium).

The first time span preferably comprises the contrast agent distributing within the examination region. Preferably, the first time span comprises the arterial phase and/or the portal-vein phase and/or the late phase in the dynamic contrast-enhanced magnetic resonance imaging of a liver or a portion of a liver of an examination object. Said phases are, for example, defined and described in the following publications: J. Magn. Reson. Imaging, 2012, 35(3): 492-511, doi:10.1002/jmri.22833; Clujul Medical, 2015, Vol. 88 no. 4: 438-448, DOI: 10.15386/cjmed-414; Journal of Hepatology, 2019, Vol. 71: 534-542, http://dx.doi.org/10.1016/j.jhep.2019.05.005).

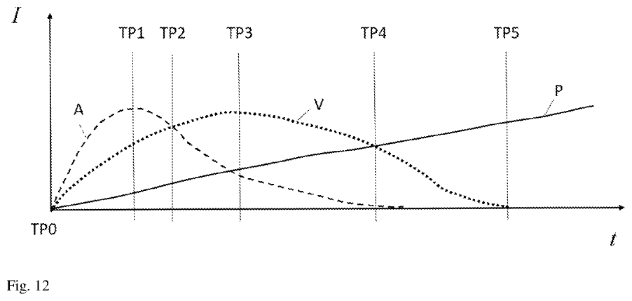

FIG. 12 shows schematically the temporal profile of the concentrations of contrast agent in liver arteries (A), liver veins (V) and healthy liver cells (P) after an administration of a hepatobiliary contrast agent into an arm vein of a person. The concentrations are depicted in the form of the signal intensities I in the stated areas (liver arteries, liver veins, liver cells) in the magnetic resonance measurement as a function of the time t. Upon an intravenous bolus injection, the concentration of the contrast agent rises in the liver arteries (A) first of all (dashed curve). The concentration passes through a maximum and then drops. The concentration in the liver veins (V) rises more slowly than in the liver arteries and reaches its maximum later (dotted curve). The concentration of the contrast agent in the healthy liver cells (P) rises slowly (continuous curve) and reaches its maximum only at a very much later time point (the maximum is not depicted in FIG. 12). A few characteristic time points can be defined: At time point TP0, contrast agent is administered intravenously as a bolus. At time point TP1, the concentration (the signal intensity) of the contrast agent in the liver arteries reaches its maximum. At time point TP2, the curves of the signal intensities for the liver arteries and the liver veins intersect. At time point TP3, the concentration (the signal intensity) of the contrast agent in the liver veins passes through its maximum. At time point TP4, the curves of the signal intensities for the liver arteries and the liver cells intersect. At time point T5, the concentrations in the liver arteries and the liver veins have dropped to a level at which they no longer cause a measurable contrast enhancement.

In a preferred embodiment, the first time span is chosen such that such MRI images of the liver or a portion of the liver of an examination object are generated
(i) that show the examination region without contrast agent,
(ii) that show the examination region during the arterial phase, in which the contrast agent spreads in the examination region via the arteries,
(iii) that show the examination region during the portal-vein phase, in which the contrast agent gets into the examination region via the portal vein, and
(iv) that show the examination region during the late phase, in which the concentration of the contrast agent in the arteries and veins declines and the concentration of the contrast agent in the liver cells rises.

Preferably, the first time span starts in a time span of one minute to one second before the administration of the contrast agent, or with the administration of the contrast agent, and lasts over a time span of 2 minutes to 15 minutes, preferably 2 minutes to 13 minutes, yet more preferably 3 minutes to 10 minutes, from the administration of the contrast agent. Since the contrast agent undergoes very slow renal and biliary excretion, the second time span can drag on for up to two hours and longer after the administration of the contrast agent.

In a preferred embodiment, the first time span comprises at least time points TP0, TP1, TP2, TP3 and TP4.

In a preferred embodiment, at least MRI images of all the following phases are generated (on the basis of measurement): in a time span before TP0, in the time span from TP0 to TP1, in the time span from TP1 to TP2, in the time span from TP2 to TP3 and in the time span from TP3 to TP4.

It is conceivable that one or more MRI images are respectively generated (on the basis of measurement) in the time spans before TP0, from TP0 to TP1, from TP1 to TP2, from TP2 to TP3 and from TP3 to TP4.

On the basis of the (first) MRI images generated (on the basis of measurement) during the first time span, a second MRI image or multiple second MRI images that show(s) the examination region during a second time span is/are predicted. MRI images which are predicted for the second time span are also referred to as second MRI images in this description.

In a preferred embodiment of the present invention, the second time span follows the first time span.

The second time span is preferably a time span within the hepatobiliary phase; preferably a time span which starts at least 10 minutes after administration of the contrast agent, preferably at least 20 minutes after administration of the contrast agent.

The at least one second representation, which represents the examination region during the second time span, is predicted with the aid of the prediction model according to the invention. The prediction model has been trained beforehand to predict, on the basis of a plurality of first MRI images showing an examination region during the first time span, one or more MRI images showing the examination region during the second time span.

The example described here is also depicted schematically in FIG. 1(b).

### Example 3

In a further preferred embodiment of the present invention, the present invention is used to differentiate lesions in the liver from blood vessels. In the case of T1-weighted MRI images, Primovist® leads, 10-20 minutes after the injection (in the hepatobiliary phase), to a distinct signal enhancement in the healthy liver parenchyma, whereas lesions containing no hepatocytes or only a few hepatocytes, for example metastases or moderately to poorly differentiated hepatocellular carcinomas (HCCs), appear as darker regions. However, the blood vessels also appear as dark regions in the hepatobiliary phase, meaning that differentiation of liver lesions and blood vessels solely on the basis of contrast is not possible in the MRI images generated during the hepatobiliary phase.

The present invention can be used to generate artificial MRI images of a liver or a portion of a liver of an examination object, in which the contrast between the blood vessels in the liver and the liver cells has been artificially minimized in order to make liver lesions more easily identifiable.

An “image” is a representation in the context of the present invention. An image can be a representation in real space or a representation in frequency space. For training of the prediction model and for prediction, use is always made of representations in frequency space. However, representations in real space can be generated on the basis of measurement, which are then, for example, converted by means of Fourier transform into representations in frequency space before they are introduced to training and/or prediction.

The plurality of first representations comprises at least one representation of the examination region in which blood vessels are identifiable, which are preferably depicted with contrast enhancement owing to a contrast agent (blood-vessel representation).

When using a paramagnetic contrast agent, the blood vessels in such a representation are characterized by a high signal intensity owing to the contrast enhancement (high-signal depiction). Those (continuous) structures within such a representation that have a signal intensity within an empirically ascertainable range can thus be attributed to blood vessels. This meant that, with such a representation, there is information about where blood vessels are depicted in a real-space depiction or which structures can be attributed to blood vessels (arteries and/or veins) in a real-space depiction.

The plurality of first representations further comprises at least one representation of the examination region in which healthy liver cells are depicted with contrast enhancement (liver-cell representation), for example a representation of the examination region that was acquired during the hepatobiliary phase.

The information from the at least one blood-vessel representation via the blood vessels is combined with the information from the at least one liver-cell representation. This involves (artificially) generating (calculating) at least one representation in which the difference in contrast between structures which can be attributed to blood vessels and structures which can be attributed to healthy liver cells has been levelled.

Here, the term “levelling” means “harmonizing” or “minimizing”. The goal of levelling is to make the boundaries between blood vessels and healthy liver cells in the artificially generated representation disappear, and to make blood vessels and healthy liver cells in the artificially generated representation appear as a uniform tissue, against which liver lesions stand out structurally owing to a different contrast.

Usually, one (number=1) artificial representation is predicted on the basis of one (number=1) blood-vessel representation and one (number=1) liver-cell representation.

It is conceivable that, in addition to at least one blood-vessel representation and at least one liver-cell representation, at least one native representation is also additionally used in order to predict the at least one artificial representation.

In one embodiment, the generation of the artificial representation comprises the following steps:
feeding the at least one blood-vessel representation and the at least one liver-cell representation to a prediction model, wherein the prediction model has been trained by means of supervised learning on the basis of reference representations to generate at least one artificial representation from at least one reference blood-vessel representation and at least one reference liver-cell representation, wherein the difference in contrast between structures which can be attributed to blood vessels, and structures which can be attributed to healthy liver cells has been levelled in the at least one artificial representation, and
receiving at least one artificial representation as the output from the prediction model.

### Example 4

In a further embodiment, the present invention is used to generate a native MRI image of the liver. Here, one or more artificial MRI images of a liver or a portion of a liver of an examination object are generated that show the liver or the portion of the liver without contrast enhancement caused by a contrast agent. The artificial MRI image(s) is/are created on the basis of MRI images which were all acquired with contrast enhancement caused by a contrast agent.

An “image” is a representation in the context of the present invention. An image can be a representation in real space or a representation in frequency space. For training of the prediction model and for prediction, use is always made of representations in frequency space. However, representations in real space can be generated on the basis of measurement, which are then, for example, converted by means of Fourier transform into representations in frequency space before they are introduced to training and/or prediction.

The examination region is introduced into a basic magnetic field. A contrast agent which spreads in the examination region is administered to the examination object. The contrast agent is preferably administered intravenously (e.g., into an arm vein) as a bolus using dosing based on body weight. Preferably, the contrast agent is a hepatobiliary contrast agent such as, for example, Gd-EOB-DTPA or Gd-BOPTA. In a particularly preferred embodiment, the contrast agent is a substance or a substance mixture having gadoxetic acid or a salt of gadoxetic acid as contrast-enhancing active substance. Very particular preference is given to the disodium salt of gadoxetic acid (Gd-EOB-DTPA disodium).

A plurality of first representations of the examination region are generated that represent the examination region in a first time span after the administration of the contrast agent. Preferably, the plurality of first representations are T1-weighted depictions.

Preferably, the plurality of first representations comprises at least one representation of the examination region that represents the examination region during the dynamic phase, for example at least one representation that represents the examination region during the arterial phase, the venous phase and/or during the late phase (see, e.g., FIG. 12 and the related explanations in Example 2). When using a paramagnetic contrast agent, the blood vessels in such representations are characterized by a high signal intensity owing to the contrast enhancement (high-signal depiction).

Preferably, the plurality of first representations further comprises at least one representation of the examination region that represents the examination region during the hepatobiliary phase. During the hepatobiliary phase, the healthy liver tissue (parenchyma) is depicted with contrast enhancement.

MRI examinations of the dynamic and the hepatobiliary phase drag on over a comparatively long time span. Over said time span, movements by the patient should be avoided in order to minimize movement artefacts in radiological images. The lengthy restriction of movement can be unpleasant for a patient. Therefore, shortened MRI procedures are now becoming established, in which a contrast agent is already administered to the examination object a certain time span (i.e., 10 to 20 minutes) before MRI image acquisition in order to be able to directly acquire MRI images within the hepatobiliary phase. MRI images of the dynamic phase are then acquired in the same MRI process after administration of a second dose of the contrast agent. In comparison with a conventional MRI process, the residence time of a patient or an examination object in MRI is distinctly shorter as a result. Therefore, according to the invention, preference is given to recording the at least one representation of the liver or the portion of the liver in the hepatobiliary phase after a (first) administration of a first contrast agent into the examination object and to recording at least one further representation of the same liver or the portion of the same liver in the dynamic phase after administration of a second contrast agent or a second administration of the first contrast agent into the same examination object. The first contrast agent is a hepatobiliary, paramagnetic contrast agent. The second contrast agent can also be an extracellular, paramagnetic contrast agent.

The first representations of the examination region are then fed to the prediction model according to the invention. The prediction model has been trained beforehand to predict, on the basis of the received first representations, one or more second representations showing the liver or a portion of the liver of the examination object without contrast enhancement caused by a contrast agent. The prediction model was preferably created with the aid of a self-learning algorithm in a supervised machine learning process. What are used for learning are training data which comprise a plurality of representations of the examination region during the dynamic phase and the hepatobiliary phase of the liver or a portion of the liver of a multiplicity of examination objects. Furthermore, the training data also comprise representations of the examination region in which no contrast enhancement was present, i.e., which were generated without administration of a contrast agent.

The example described here is also depicted schematically in FIG. 1(c).

### Example 5

In a further preferred embodiment, the present invention is used to reduce a patient's examination time in the dynamic contrast-enhanced magnetic resonance imaging of the liver.

Here, contrast agent is administered in the form of two boluses. The first administration is done at a time point at which the examination object is not yet situated in the MRI scanner. In the case of the first administration, a first contrast agent is administered. The first contrast agent is preferably administered intravenously as a bolus using dosing based on body weight (e.g., into an arm vein). The first contrast agent is preferably a hepatobiliary contrast agent such as, for example, Gd-EOB-DTPA or Gd-BOPTA. In a particularly preferred embodiment, the first contrast agent is a substance or a substance mixture having gadoxetic acid or a salt of gadoxetic acid as contrast-enhancing active substance. Very particular preference is given to the disodium salt of gadoxetic acid (Gd-EOB-DTPA disodium).

After the administration of the first contrast agent, a time span can be waited for before the examination object is introduced into the MRI scanner and a first MRI image is generated at a first time point.

An “image” is a representation in the context of the present invention. An image can be a representation in real space or a representation in frequency space. For training of the prediction model and for prediction, use is always made of representations in frequency space. However, representations in real space can be generated on the basis of measurement, which are then, for example, converted by means of Fourier transform into representations in frequency space before they are introduced to training and/or prediction.

The time span between the first administration and the generation of the first MRI image is preferably within the range from 5 minutes to 1 hour, yet more preferably within the range from 10 minutes to 30 minutes, and most preferably within the range from 8 minutes to 25 minutes.

The first MRI image represents the liver or a portion of the liver of the examination object during the hepatobiliary phase after the administration of the first contrast agent. Healthy liver cells are depicted with contrast enhancement in the first MRI image as a consequence of the administration of the first contrast agent.

The hepatobiliary phase in which the first MRI image is generated is also referred to as first hepatobiliary phase in this description. The first contrast agent has reached the healthy liver cells and leads to contrast enhancement, to signal enhancement of the healthy liver cells in the case of a paramagnetic contrast agent. During the arterial phase, the portal-vein phase and the late phase which occur after the administration of the first contrast agent, no MRI images are generated. The arterial phase, the portal-vein phase and the late phase which occur after the administration of the first contrast agent are also referred to as first arterial phase, first portal-vein phase and first late phase in this description.

It is conceivable that multiple MRI images are generated during the first hepatobiliary phase.

After the generation of one or more first MRI images during the first hepatobiliary phase, contrast agent is administered a second time. What is administered the second time is a second contrast agent. The second contrast agent can be the same contrast agent as the first contrast agent; however, the second contrast agent can also be a different contrast agent, preferably an extracellular one. The second contrast agent is likewise preferably administered intravenously as a bolus using dosing based on body weight (e.g., into an arm vein).

The administration of the first contrast agent is also referred to as first administration in this description; the administration of the second contrast agent is also referred to as second administration in this description. If the first contrast agent and the second contrast agent are identical, then what thus takes place is a first administration of a hepatobiliary contrast agent and, at a later time point, a second administration of the hepatobiliary contrast agent. If the first contrast agent and the second contrast agent are different, what takes place is a first administration of a first contrast agent, said first contrast agent being a hepatobiliary contrast agent, and what takes place at a later time point is a second administration of a second (different) contrast agent.

At the time point of the second administration (or at the time point of the administration of the second contrast agent), the examination object is preferably already situated in the MRI scanner. After the administration of the second contrast agent, an arterial phase, a portal-vein phase phase and a late phase is again passed through. Said arterial phase, portal-vein phase and late phase are also referred to as second arterial phase, second portal-vein phase and second late phase in this description. In the second arterial phase and/or in the second portal-vein phase and/or in the second late phase, an MRI image or multiple MRI images is/are generated. Said MRI images are referred to in the order of their acquisition as second, third, fourth, etc.

In a preferred embodiment, a second MRI image is generated during the second arterial phase, a third MRI image is generated during the second portal-vein phase and a fourth MRI image is generated during the second late phase. Such a second MRI image shows especially arteries with contrast enhancement; such a third MRI image shows especially veins with contrast enhancement.

It is further conceivable that more than one MRI image is generated during the stated phases.

From the MRI images which were generated during one or more phases after the administration of the first and the second contrast agent, it is then possible to calculate artificial MRI images.

The goal of generating artificial MRI images from the measured MRI images is to increase the contrast between healthy liver tissue and other regions. When using a hepatobiliary paramagnetic contrast agent as the first contrast agent, the signal intensity of healthy liver tissue during the second arterial phase, the second portal-vein phase and the second late phase is still elevated as a consequence of the administration of the first contrast agent. The second contrast agent which spreads in the stated second phases likewise leads to an elevated signal in the tissue in which it spreads. This means that there is only a low contrast in the MRI images between the healthy liver tissue and the remaining tissue, which remaining tissue is contrast-enhanced due to (second) contrast agent. In order to increase this contrast, what is generated with the aid of a prediction model is at least one artificial MRI image which would show the examination region as how it looked in the dynamic phase after administration of the first contrast agent or how it would look if only the second contrast agent had been administered: the blood vessels are depicted with contrast enhancement as a consequence of the administration of the second contrast agent, but healthy liver cells are not depicted with contrast enhancement as a consequence of the administration of a first contrast agent. In other words, what is generated is an artificial MRI image which looks like the second MRI image, with the difference that the contrast enhancement of the healthy liver cells, which was caused by the administration of the first contrast agent, is subtracted (eliminated) from the second MRI image.

The example described here is also depicted schematically in FIG. 1(d).

1: A computer-implemented method comprising:
receiving a plurality of first representations of an examination region of an examination object in frequency space, wherein at least some of the first representations represent the examination region during a first time span after an administration of a contrast agent;
feeding the plurality of first representations to a prediction model, wherein the prediction model has been trained using first reference representations of the examination region of a multiplicity of examination objects to generate, from the first reference representations, of which at least some represent the examination region during the first time span after an administration of a contrast agent in frequency space, one or more second reference representations which represent the examination region during a second time span in frequency space;
receiving one or more predicted representations of the examination region in frequency space from the prediction model, wherein the one or more predicated representations represent the examination region during the second time span;
transforming the one or more predicted representations into one or more representations of the examination region in real space; and
outputting the one or more representations of the examination region in real space.

2: The method of claim 1, wherein the plurality of first representations comprises:
at least one representation of the examination region in frequency space that represents the examination region before the administration of the contrast agent; and
at least one representation of the examination region in frequency space that represents the examination region in the first time span after the administration of the contrast agent,
wherein the second time span comes after the first time span.

3: The method of claim 1, wherein:
the plurality of first representations comprises at least two representations of the examination region in frequency space that represent the examination region in the first time span after the administration of the contrast agent; and
the second time span comes before the first time span.

4: The method of claim 1, wherein the plurality of first representations comprises:
at least one representation of the examination region in frequency space that represents the examination region in the first time span after the administration of a first contrast agent; and
at least one representation of the examination region in frequency space that represents the examination region in the first time span after the administration of a second contrast agent, wherein the second contrast agent was administered after the first contrast agent,
wherein the second time span comes before the first time span.

5: The method of claim 1, wherein the one or more predicted representations represent the examination region in the second time span with a contrast enhancement that is constant over time.

6: The method of claim 1, wherein the prediction model comprises an artificial neural network.

7: The method of claim 1, wherein the first representations of the examination region in frequency space are k-space data of a magnetic resonance imaging examination.

8: The method of claim 1, comprising:
receiving a plurality of radiological images of the examination region in real space; and
converting the received plurality of radiological images of the examination in real space into the first representations of the examination region in frequency space using Fourier transforms.

9: The method of claim 1, comprising:
specifying a region in the plurality of first representations of the examination region, wherein the specified region comprises the center of the frequency space;
reducing the first representations to the specified region;
feeding the plurality of reduced first representations to the prediction model;
receiving one or more second representations of the examination region in frequency space from the prediction model, wherein the one or more second representations represent the examination region during the second time span;
supplementing the one or more second representations by one or more regions of the received first representations that lie outside the specified region;
transforming the one or more supplemented second representations into one or more representations of the examination region in real space; and
outputting the one or more representations of the examination region in real space.

10. The method of claim 9, wherein the one or more supplemented second representations are transformed into one or more representations of the examination region in real space using inverse Fourier transforms.

11: A system comprising one or more processors configured to:
receive a plurality of first representations of an examination region of an examination object in frequency space, wherein at least some of the first representations represent the examination region during a first time span after an administration of a contrast agent;
feed the plurality of first representations to a prediction model, wherein the prediction model has been trained on the basis of using first reference representations of the examination region of a multiplicity of examination objects to generate, from the first reference representations, of which at least some represent the examination region during the first time span after an administration of a contrast agent in frequency space, one or more second reference representations which represent the examination region during a second time span in frequency space;
receive one or more predicted representations of the examination region in frequency space from the prediction model, wherein the one or more predicted representations represent the examination region during the second time span;
transform the one or more predicted representations into one or more representations of the examination region in real space; and
output the one or more representations of the examination region in real space.

12: A non-transitory computer readable storage medium storing instructions that, when executed by one or more processors of a computer system, cause the computer system to:
receive a plurality of first representations of an examination region of an examination object in frequency space, wherein at least some of the first representations represent the examination region during a first time span after an administration of a contrast agent;
feed the plurality of first representations to a prediction model, wherein the prediction model has been trained using first reference representations of the examination region of a multiplicity of examination objects to generate, from the first reference representations, of which at least some represent the examination region during the first time span after an administration of a contrast agent in frequency space, one or more second reference representations which represent the examination region during a second time span in frequency space;
receive one or more predicted representations of the examination region in frequency space from the prediction model, wherein the one or more predicated representations represent the examination region during the second time span;
transform the one or more predicted representations into one or more representations of the examination region in real space; and
output the one or more representations of the examination region in real space.

13: Use of a contrast agent in a method for predicting at least one radiological image, wherein the method comprises:
administering the contrast agent, wherein the contrast agent spreads in an examination region of an examination object;
generating a plurality of first representations of the examination region of the examination object in frequency space, wherein at least some of the first representations represent the examination region during a first time span after an administration of the contrast agent;
feeding the plurality of first representations to a prediction model, wherein the prediction model has been trained using first reference representations of the examination region of a multiplicity of examination objects to generate, from the first reference representations, of which at least some represent the examination region during the first time span after an administration of a contrast agent in frequency space, one or more second reference representations which represent the examination region during a second time span in frequency space;
receiving one or more predicted representations of the examination region in frequency space from the prediction model, wherein the one or more predicated representations represent the examination region during the second time span;
transforming the one or more predicted representations into one or more representations of the examination region in real space; and
outputting the one or more representations of the examination region in real space.

14: Contrast agent for use in a method for predicting at least one radiological image, wherein the method comprises:
administering the contrast agent, wherein the contrast agent spreads in an examination region of an examination object;
generating a plurality of first representations of the examination region of the examination object in frequency space, wherein at least some of the first representations represent the examination region during a first time span after an administration of the contrast agent;
feeding the plurality of first representations to a prediction model, wherein the prediction model has been trained using first reference representations of the examination region of a multiplicity of examination objects to generate, from the first reference representations, of which at least some represent the examination region during the first time span after an administration of a contrast agent in frequency space, one or more second reference representations which represent the examination region during a second time span in frequency space;
receiving one or more predicted representations of the examination region in frequency space from the prediction model, wherein the one or more predicated representations represent the examination region during the second time span;
transforming the one or more predicted representations into one or more representations of the examination region in real space; and
outputting the one or more representations of the examination region in real space.

15: A comprising a contrast agent and the non-transitory computer readable storage medium of claim 12.
